(19) United States
(12) Patent Application Publication
(10) Pub. No.: US 2009/0248457 A1
(43) Pub. Date: Oct. 1, 2009

(54) System and Method for Providing Travel Schedule of Contacts

(75) Inventors: Aaron MUNTER, San Francisco, CA (US); Mitra NAEIMI, Hillsborough, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: REARDEN COMMERCE, INC., Foster City, CA (US)

(21) Appl. No.: 12/059,947

(22) Filed: Mar. 31, 2008

(51) Int. Cl. G06Q 10/00

(52) U.S. Cl. 705/5

(57) ABSTRACT

One embodiment provides a method, that may be implemented on a system, for providing the travel schedule of traveler's contacts. One embodiment of the method comprises receiving a travel itinerary for a traveler; identifying at least one travel segment option corresponding to the travel itinerary of the traveler; identifying from one or more of the traveler's sets of contacts, one or more contacts that have selected the travel segment option identified for the traveler; and presenting for selection the travel segment option for the traveler, and presenting the one or more contacts that have selected the travel segment option identified for the traveler.

### BACKGROUND OF THE INVENTION

When making travel plans, a traveler may be interesting to know if an acquaintance, co-worker, friend, family member, or other person in his social network may also be traveling on the same date to the same place; and, if so, whether the traveler and the other person or persons of interest could then travel on the same carrier, and even sit together. It is known to the inventor that in group reservations within companies, for example, reservations for one person or persons may be attached to the travel schedule of some other traveler. However, in many cases, this feature is not applicable or of interest. For example, a traveler may be interested in meeting customers or other professional associates while in transit, or, similarly, traveling together with just friends or family.

What is clearly needed is a system and method that allows a traveler to see, during the reservation process, the travel details of other people in his social network, and thus to be able to arrange to travel together on the same carrier.

### SUMMARY

Some embodiments of the present invention are summarized in this section.

One embodiment provides a method, that may be implemented on a system, for providing the travel schedule of traveler's contacts. One embodiment of the method comprises receiving a travel itinerary for a traveler; identifying at least one travel segment option corresponding to the travel itinerary of the traveler; identifying from one or more of the traveler's sets of contacts, one or more contacts that have selected the travel segment option identified for the traveler; and presenting for selection the travel segment option for the traveler, and presenting the one or more contacts that have selected the travel segment option identified for the traveler.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DESCRIPTION OF THE EMBODIMENTS

The disclosure is illustrated by way of example and not limitation in the figures of the accompanying drawings in which like references indicate similar elements.

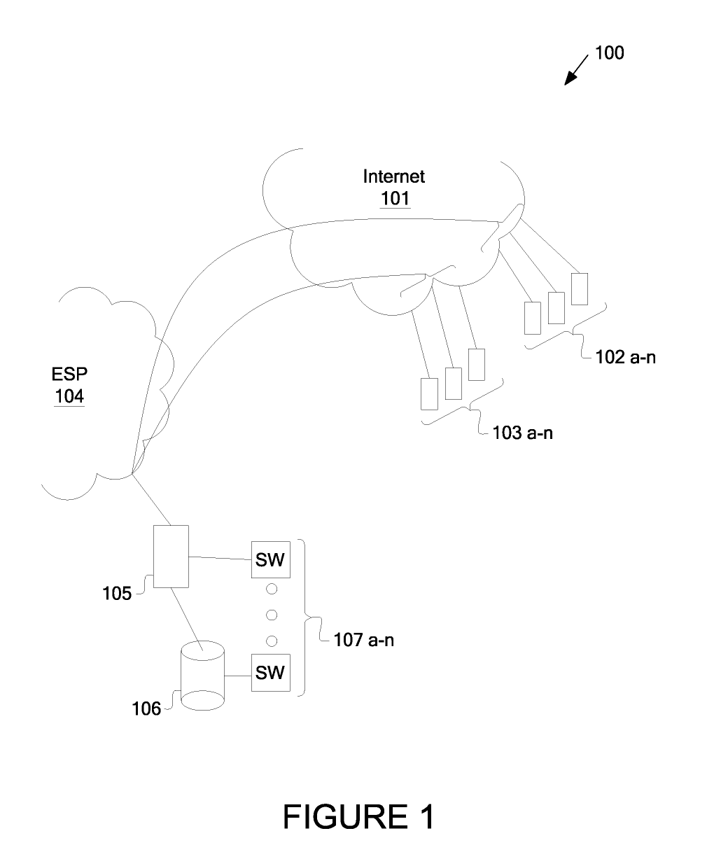

FIG. 1 shows an exemplary overview of a system according to one embodiment of the current invention;

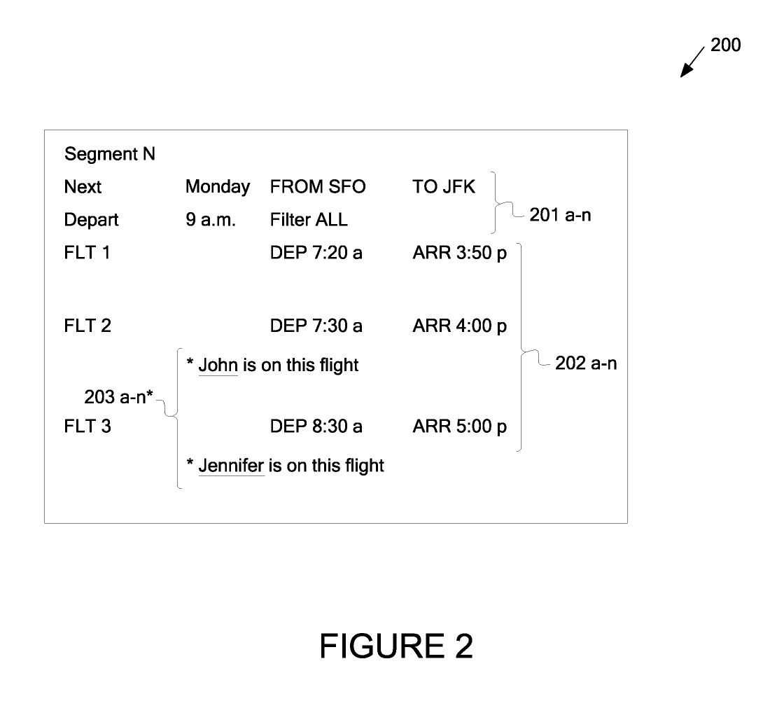

FIG. 2 shows a simplified view of a screen 200 with an exemplary display of a social networking reservation matching system, according to one embodiment;

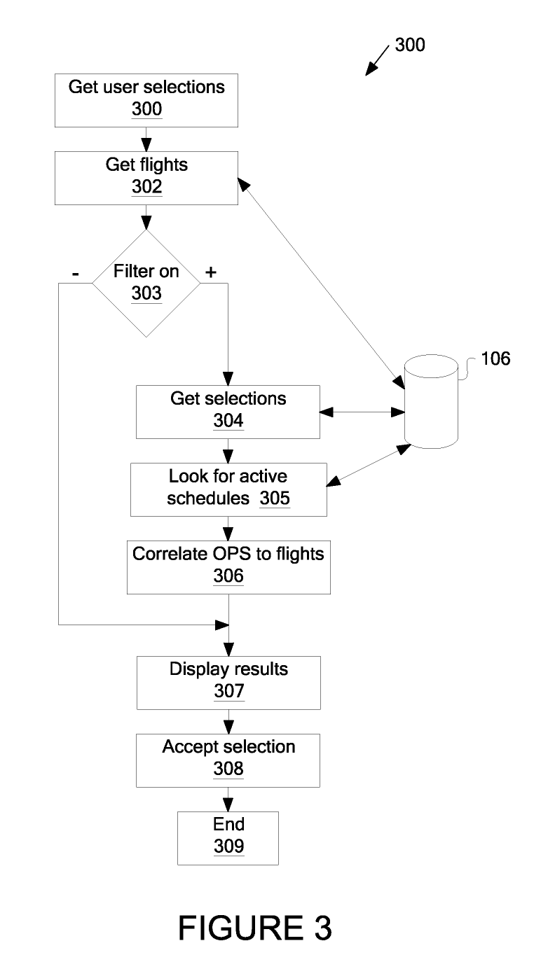

FIG. 3 shows an exemplary process for implementation of the system, according to one embodiment of the present invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 shows an exemplary system 100 according to one embodiment of the current invention. An electronic services portal ESP 104 connects to a server 105 and a data repository 106. The server hosts social network reservation-matching software instances 107a-n of the present invention, plus basic elements of the overall system, such as the operating system, as well as any other inherently needed or present software, which, depending on the implementation of the system, may be one, several, or many instances. These software instances are to be considered only exemplary indications of how the software could be installed in server 105 and how it could work in conjunction with ESP 104, Personal Information Managers (PIMs, not shown), and main data repository 106. System 104 connects via Internet 101 to system users 103a-n and suppliers 102a-n. It is clear that these connections could also be through direct connection, through a phone system, or through any other suitable networking method, known or to be invented.

FIG. 2 shows a simplified view of a screen 200 with an exemplary display of a social networking reservation matching system, according to one embodiment of the current invention. A user enters preference information 201a-n for a travel segment; which information, in this case, for a flight from San Francisco to New York, includes data such as day, date, start location and time, destination location, etc. Also, the user may set filter values for the social networking connections he wishes to view. In this example, the networking filter is set for “ALL” connections, meaning all contacts are displayed, including private social contacts, business contacts, co-workers, etc. Flights 202a-n that meet the entered travel criteria appear on the display below the values. Contacts 203a-n appear in also on the display, interlaced with their respective flights. In this example, the system reports that connection John has a reservation on Flight 2 and connection Jennifer has a reservation on Flight 3. Thus the traveler may book the flight that is already booked by the contact, such as either John or Jennifer, with whom he prefers to travel. It is clear that the system disclosed herein may be implemented with many variations. In particular, the system may have the ability to mask members of the network, both at the request of the traveler looking for connections and at the request of other travelers in the social network who have already booked a reservation. Thus on Flight 3 another member of the social network, Jason, may also be traveling, but his name may be masked so that the user cannot see it. This masking may be requested by an individual user or may be put in place as part of a corporate policy (not shown).

FIG. 3 shows an exemplary method 300 for implementation of the system according to one embodiment of the present invention. In process 301 system obtains the user's travel segment preferences, entered by the user as data 201a-n, described above. In process 302, the system obtains corresponding flight information from main data repository 106. At process 303, the process branches. If a filter is not on (−), the process moves directly to process 307, described below. If a filter is on (+), in process 304, the system obtains selections from main data repository 106 according to the particular filter, and in process 305 the system looks in main data repository 106 for flight schedules that match any pertinent criteria of the selections obtained in the previous process. In process 306 the system correlates other people's schedules (OPS) to the flights obtained in the previous process, and in process 307, the system displays flight and social networking contact information, as shown in the example in FIG. 2, described above. The user may select a flight, which the system accepts in process 308, and the process ends in process 309.

It is clear that many modifications and variations of this embodiment may be made by one skilled in the art without departing from the spirit of the novel art of this disclosure. In some cases, such as, for example, where a great many contacts are available on a selection of flights (for example, when many contacts are all traveling to a trade show), instead of overcrowding the display by listing each network contact, the system may display classes of available contacts by a system of color-coded icons. When the user runs the mouse over an icon, a box opens listing the available contacts in that class. Additionally, in some cases, a user may wish to send a message to another contact or contacts, saying that he plans to join them on this travel segments, so they can synchronize other travel arrangements, such as seating, transportation to and from travel terminals, meetings, etc. By seeing the contacts during the reservation process, a user may adjust his reservations, for example, to fly in the same class as a friend, etc. These and many other variations do not depart from the broader spirit and scope of the invention, and the examples cited here are to be regarded in an illustrative rather than a restrictive sense.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSIs), application-specific integrated circuits (ASICs), and firmware such as electrically erasable programmable read-only memory (EEPROMs).

It is clear that many modifications and variations of this embodiment may be made by one skilled in the art without departing from the spirit of the novel art of this disclosure. These modifications and variations do not depart from the broader spirit and scope of the invention, and the examples cited here are to be regarded in an illustrative rather than a restrictive sense.

What is claimed is:

1. A computer-implemented method comprising:
receiving a travel itinerary for a traveler;
identifying at least one travel segment option corresponding to the travel itinerary of the traveler;
identifying from one or more of the traveler's sets of contacts, one or more contacts that have selected the travel segment option identified for the traveler; and
presenting for selection the travel segment option for the traveler, and presenting the one or more contacts that have selected the travel segment option identified for the traveler.

2. The computer-implemented method of claim 1, wherein the sets of contacts include one or more of social contacts, business contact, or co-workers.

3. The computer-implemented method of claim 1, prior to identifying one or more contacts that have selected the travel segment option identified for the traveler, determining if the traveler has set a filter to be used to identify if a contact has selected the travel segment option identified for the traveler.

4. The computer-implemented method of claim 3, wherein the identifying one or more of the traveler's contacts that have selected the travel segment option identified for the traveler further includes masking one or more of traveler's contacts from being identified.

5. The computer-implemented method of claim 4, wherein the masking is in response to a selection by the traveler.

6. The computer-implemented method of claim 4, wherein the masking is in response to a selection by a respective contact to be masked.

7. The computer-implemented method of claim 4, wherein the masking is set in accordance with an employer policy.

8. The computer-implemented method of claim 1, in response to receiving a selection of the travel segment option for the traveler, booking the traveler for the travel segment.

9. The computer-implemented method of claim 1, wherein the travel segment comprises one or more of a transportation segment, an overnight accommodation, or a restaurant accommodation.

10. The computer-implemented method of claim 1, wherein the presenting further includes presenting, in separate groups, the contacts that have selected the travel segment option identified for the traveler.

11. A machine-readable medium having stored thereon a set of instructions, which when executed perform a method comprising:
receiving a travel itinerary for a traveler;
identifying at least one travel segment option corresponding to the travel itinerary of the traveler;
identifying from one or more of the traveler's sets of contacts, one or more contacts that have selected the travel segment option identified for the traveler; and
presenting for selection the travel segment option for the traveler, and presenting the one or more contacts that have selected the travel segment option identified for the traveler.

12. The machine-readable medium of claim 11, wherein the sets of contacts include one or more of social contacts, business contact, or co-workers.

13. The machine-readable medium of claim 11, prior to identifying one or more contacts that have selected the travel segment option identified for the traveler, determining if the traveler has set a filter to be used to identify if a contact has selected the travel segment option identified for the traveler.

14. The machine-readable medium of claim 13, wherein the identifying one or more of the traveler's contacts that have selected the travel segment option identified for the traveler further includes masking one or more of traveler's contacts from being identified.

15. The machine-readable medium of claim 14, wherein the masking is in response to a selection by the traveler.

16. The machine-readable medium of claim 14, wherein the masking is in response to a selection by a respective contact to be masked.

17. The machine-readable medium of claim 14, wherein the masking is set in accordance with an employer policy.

18. The machine-readable medium of claim 11, in response to receiving a selection of the travel segment option for the traveler, booking the traveler for the travel segment.

19. The machine-readable medium of claim 11, wherein the presenting further includes presenting, in separate groups, the contacts that have selected the travel segment option identified for the traveler.

20. A system comprising:
a unit to receive a travel itinerary for a traveler;
a unit to identify at least one travel segment option corresponding to the travel itinerary of the traveler;
a unit to identifying from one or more of the traveler's sets of contacts, one or more contacts that have selected the travel segment option identified for the traveler; and
a unit to present for selection the travel segment option for the traveler, and presenting the one or more contacts that have selected the travel segment option identified for the traveler.
